(19) United States
(12) Patent Application Publication
(10) Pub. No.: US 2015/0157534 A1
(43) Pub. Date: Jun. 11, 2015

(54) FLEXIBLE CONTAINER WITH OUTLET

(71) Applicants: Alexander Josephus Maricus Van Puijenbroek, Wageningen (NL); Anne Peter Rombout Van Seters, Utrecht (NL)

(72) Inventors: Alexander Josephus Maricus Van Puijenbroek, Wageningen (NL); Anne Peter Rombout Van Seters, Utrecht (NL)

(73) Assignee: N.V. NUTRICIA, Zoetermeer (NL)

(21) Appl. No.: 14/405,509

(22) PCT Filed: Jun. 8, 2012
(86) PCT No.: PCT/NL2012/050401

§ 371 Date: Feb. 6, 2015

(51) Int. Cl. A61J 1/14; B65B 3/04; B65B 55/04

(52) U.S. Cl. CPC A61J 1/14; B65B 55/04; B65B 3/04

(57) ABSTRACT

A container for a liquid nutritional product includes a thermoformed polymeric container body having a base and an upstanding sidewall defining a product space, the upstanding sidewall terminating at a peripheral flange. A cover is permanently sealed to the peripheral flange and an outlet is provided on an outlet region of the container body. The outlet defines a flow channel for the liquid nutritional product to leave the product space and, in a storage condition, the flow channel is directed at least partially downwards in a direction away from the cover and towards the base. For administration, the outlet region is deformable to an administration position where the flow channel is directed sideways in a direction parallel to the base.

### BACKGROUND OF THE INVENTION

1. Field of the Invention

The present invention relates to containers for liquid nutritional products, and in particular to containers for use in enteral feeding systems. The invention further relates to an enteral feeding system incorporating such a container.

2. Description of the Related Art

Various devices for administering fluids to patients are known in the art. Such administration may take place intravenously into a vein or enterally by intubation into a portion of the intestine. Enteral feeding may take place via a nasogastric tube, gastric tube or into the jejunum according to patient requirements. Fluids to be administrated are generally subject to high standards of hygiene and sterilisation, in particular since the receiving patient may be weak and already vulnerable to infection.

Conventionally, fluid containers have been made from extruded polymer film material. The film is heat-sealable and can be formed into pouches and provided with appropriate access ports. After filling with solution and sealing, the pouch may be sterilised by autoclaving, irradiation or the like. One container of this type has been described in EP0232171.

More recently, a container has been proposed in WO 2009/113850, the contents of which are incorporated herein by reference in their entirety. According to this disclosure, a thermoformed container body is provided having a flange around its upper side. The body is permanently sealed across a face of the flange by a polymer film, to which an outlet port is attached. The container has certain advantages over conventional pouches in terms of its ability to be filled and sterilised. Nevertheless, in certain circumstances the position of the outlet port may be inconvenient, particularly when filled containers are to be packed and stored.

It would therefore be desirable to provide an alternative container in which at least some of these inconveniences may be overcome.

### BRIEF SUMMARY OF THE INVENTION

According to the invention there is provided a container for a liquid nutritional product, comprising: a thermoformed polymeric container body having a base and an upstanding sidewall defining a product space, the upstanding sidewall terminating at a peripheral flange; a cover, permanently sealed to the peripheral flange; and an outlet, provided on an outlet region of the container body, defining a flow channel for the liquid nutritional product to leave the product space, wherein in a manufactured or storage position, the flow channel is directed at least partially downwards in a direction away from the cover and towards the base and wherein the outlet region is deformable to an administration position where the flow channel is directed sideways in a direction parallel to the base. As a result of this location of the outlet and the flow channel, interference during stacking can be avoided and easy dispensing of the contents of the container can be facilitated. In the present context, reference to upwards, downwards and sideways is with reference to the container when supported by its base. It will be understood that when hung from an infusion stand or the like, the container may be oriented with the outlet region at the lowermost side and the base and cover may hang substantially vertically. For this purpose, the container may be provided with a hanger at its end opposite to the outlet region. This hanger may be provided by an opening or eye or by a bail or label or the like.

In one preferred embodiment of the invention, the outlet region may be deformable between two stable positions defining the storage position and the administration position. Once moved to the administration position, the outlet region and the flow channel will thereafter remain in this position during use. This can be of significance when connected to a tubing set as the tubing will then remain in position throughout administration of the product.

Preferably, the outlet comprises a flange element, permanently connected to the outlet region. The outlet may be affixed to the outlet region by gluing or welding the flange onto the outlet region. This may take place either prior to filling or thereafter and may even be carried out during preparations for use.

In a preferred embodiment the outlet comprises a tubular connector for connection to an administration set. The skilled person will be well aware of the connectors that may be applied, depending upon the nature of the product that is to be dispensed. The connector may be otherwise conventional such as a Luer or Luerlock connector or the like. Most preferably, this will be a connector meeting the requirements of the ISO/IEC 80369-3 standard for small bore connectors for enteral applications.

In a further preferred embodiment, the container body and the cover together hermetically seal the product space prior to use whereby no other elements come into contact with the product. The aseptic condition of the product and its protection from deterioration are thus determined only by these two components and not by the outlet or a connector. Preferably, part of the outlet region aligned with the flow channel can be broken or pierced in order to communicate the flow channel with the product space.

In one embodiment, the outlet region closely engages with the cover. In an alternative embodiment, a shelf may be formed in the sidewall at a position intermediate of the peripheral flange and the base. This can serve to space the inside end of the outlet from the cover. In the case that a sharpened end is provided on the outlet for piercing the outlet region, this may also prevent accidental damage to the cover. The shelf may be generally horizontal or may be angled partially sideways.

In a further embodiment, the sidewall may define a container profile and the outlet region can be recessed within the container profile in its manufactured condition. Such an arrangement can give significant advantages of strength to the container and can also facilitate stacking of containers since the outlet can also be located in the recessed region of the container body. The shape of such a recessed region also facilitates stable positioning of the outlet in either the storage position or the administration position. This may be achieved if the outlet region is concave with respect to the adjoining regions of the container. On movement to the administration position, the outlet region may become at least partially convex.

Various materials may be used for manufacturing the container. In one embodiment, the polymeric container body may be a laminate comprising a layer of polyamide (PA), polyester (PET), polypropylene (PP), polyethylene (PE) or combinations thereof. A gas-tight barrier layer may also be provided, for instance of EVOH. The gas-tight barrier may be located at an inner surface of the laminate. The cover may comprise a layer of (Oriented)-PA, (O-)PP, (O-)PET, PE or PP, which may also be provided with a gas-tight barrier. In an embodiment, the cover has a thickness of about 50-70 microns.

Preferably the container body is formed of a flexible material such as a single or multi-layer laminate. In the present context flexible is understood to refer to a material which can collapse during use to eliminate the product space. This can allow the whole content of the container to be dispensed without requiring introduction of air into the container. It will be understood that minimal amounts of product will remain, generally less than 5% of the original content and even less than 1% of the original content.

In an alternative embodiment, the container body is formed of a relatively rigid material. In this context relatively rigid is intended to denote a material which when emptied will retain its original shape. It should also be sufficiently strong that a filled container can support another filled container in a stable stack without collapsing. In the case of a rigid container, an air inlet may be provided during administration.

The invention also relates to a container as described above, filled with a quantity of aseptic liquid nutritional product. The product may include any form of enteral feeding fluid including, but not limited to Nutrison™, available from Nutricia N.V. of The Netherlands.

The invention further comprises a method of providing a prefilled, sterile package containing enteral feed, comprising: thermoforming a polymer layer to form a container body having an upstanding sidewall, a peripheral flange and an outlet region; filling the container with enteral feed; sterilising the package; applying a cover over the container body; sealing the cover to the peripheral flange; and connecting an outlet to the outlet region. The above stages in the process may take place in the order given although this need not be the case. In particular, the outlet may be connected before or after filling and sealing of the package.

In a preferred mode of manufacture, the outlet is connected to the outlet region by welding. This can be performed by any appropriate welding technique including ultrasound, friction, heat and the like. Other procedures including adhesives may also be employed.

The method may also comprise administration of the product from the container including pivoting the outlet from a storage position to an administration position by deformation of the outlet region. Administration of the content of the package may then occur e.g. by connecting an administration set to the outlet. In one embodiment, connecting of the administration set may cause rupture of a portion of the outlet region.

### BRIEF DESCRIPTION OF THE DRAWINGS

The features and advantages of the invention will be appreciated upon reference to the following drawings of a number of exemplary embodiments, in which:

FIG. 1 shows a cross-sectional view of a container according to a first embodiment of the present invention;

FIG. 2 shows a view from below of the container of FIG. 1;

FIG. 3 shows a cross-sectional side view of the container of FIG. 1 in an administration position;

FIG. 4 shows the container of FIG. 3 in perspective view;

FIG. 5 shows a container according to a second embodiment of the invention in perspective view;

FIG. 6 shows the container of FIG. 5 in its administration position;

FIG. 7 shows in perspective view a number of containers according to FIG. 5 stacked together; and

FIG. 8 shows a container in perspective view according to a third embodiment of the invention.

### DESCRIPTION OF ILLUSTRATIVE EMBODIMENTS

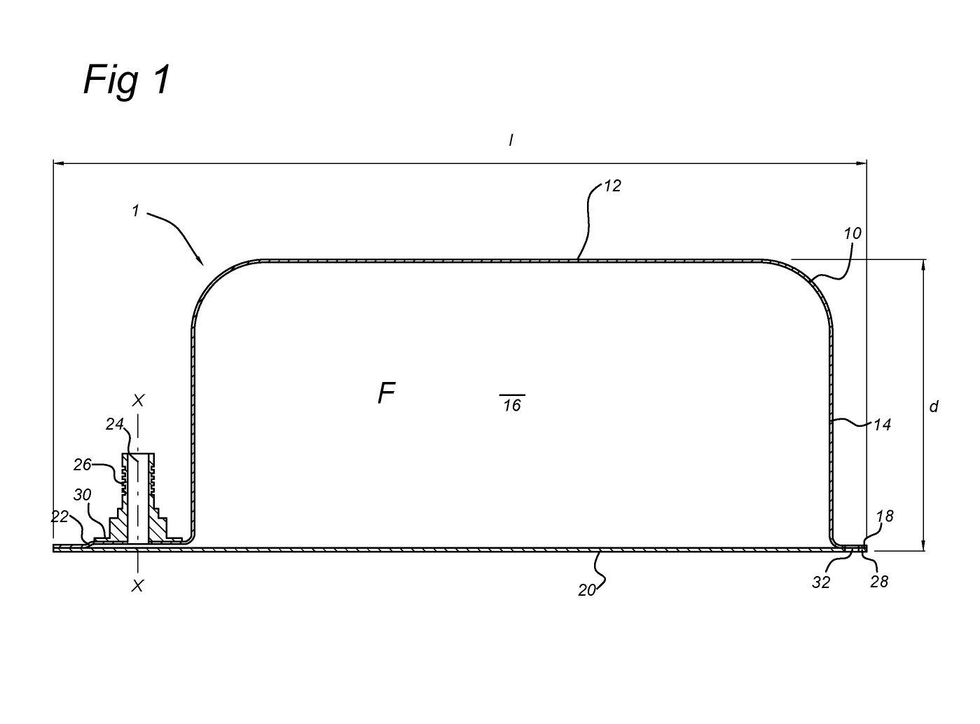

FIG. 1 shows a cross-sectional side view of a container 1 for a liquid nutritional product. The container 1 is shown in a storage position and has a container body 10 having a generally horizontal base 12 and an upstanding sidewall 14 defining a product space 16. The sidewall 14 terminates at a peripheral flange 18 which extends in a horizontal plane outwardly from the sidewall 14. A cover 20, closes the product space 16 and is connected to the peripheral flange 18 in a permanent weld 28. At one end of the container 1, the flange 18 is widened to form an outlet region 22. An outlet 26 defining a flow channel 24 is connected to the outlet region 22 by a flange element 30. The outlet 26 and flow channel 24 are generally aligned along an axis X with the outlet 26 directed downwards in the direction of the base 12. Enteral feed F is contained within the product space 16.

The container body 10 is formed from a flexible laminate that has been thermoformed by deep drawing from a sheet. The laminate has a nominal thickness of about 150 microns after forming and comprises polyamide with a layer of ethylene-vinyl alcohol copolymer (EVOH) as a gas barrier. The skilled person will be well aware of other suitable materials that can be used for this laminate which may be a single layer or multi-layer laminate. It will also be understood that a more rigid material may be used if additional strength is desired. In the embodiment shown, the overall size of the container body 10 has a depth d of around 75 mm a length l of around 200 mm and a width w of around 106 mm. The nominal capacity of the product space is 1200 cc. The cover 20 is formed of an extruded laminate of oriented polyamide, also provided with a barrier layer of EVOH. Here too, the skilled person will be well aware of alternative materials that may be employed. The cover has a thickness of 70 microns. For both the cover 20 and the body 10, the EVOH layer has itself a thickness of 30 microns and is located on the side directed towards the product space 16.

The outlet 26 and flange element 30 are formed of relatively rigid PVC material, although other suitable materials may also be employed. In particular, the outlet may be according to ISO/IEC 80369-3 standard for small bore connectors for enteral applications, the contents of which are hereby incorporated by reference in their entirety. The flange element 30 is connected to the outlet region by ultrasonic welding. Nevertheless, the skilled person will be well aware that other equivalent connection techniques may be employed.

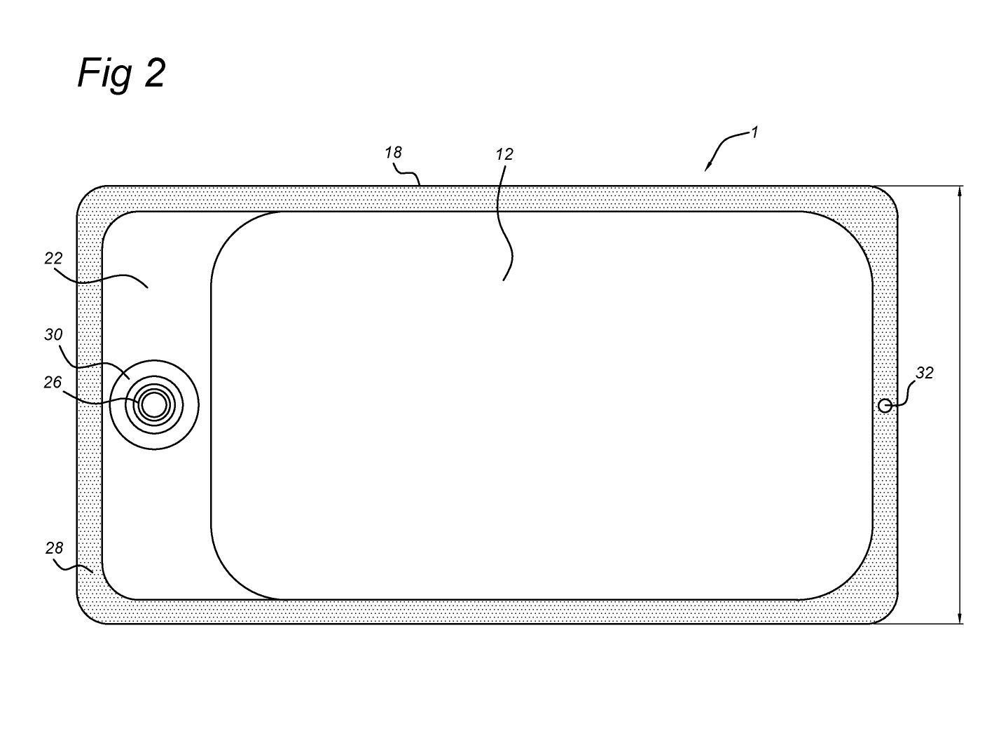

FIG. 2 shows a view from below of the container 1 of FIG. 1, showing the base 12, the peripheral flange 18, the outlet region 22, the outlet 26, flange element 30 and the weld 28. Also visible in FIG. 2 is an opening 32 formed through the flange 18 diametrically opposite to the outlet 26. This opening 32 or eye, may be used for hanging up the container 1 during use.

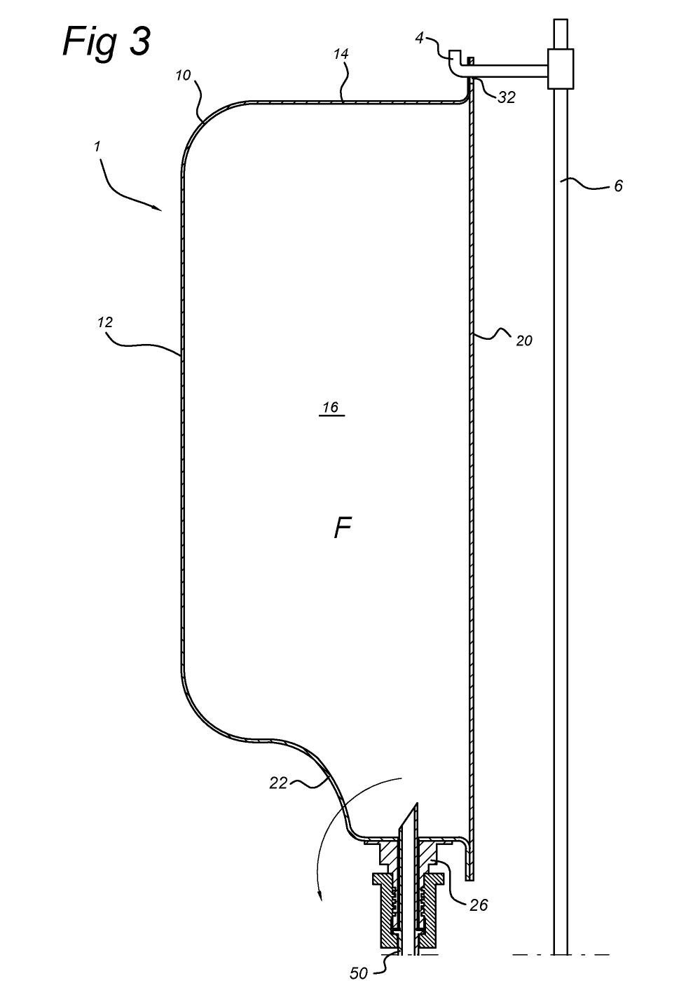

FIG. 3 shows a cross-sectional side view of the container 1 of FIG. 1 in an administration position during use for the administration of enteral feed to a patient. In this position, the container 1 is supported vertically by opening 32 from a hook 4 carried on stand 6. The outlet 26 and outlet region 22 are located at a lower end of the container 1. An administration set 50 is connected to the outlet 26, which also extends vertically downwards. It is noted that, with respect to the storage position of FIG. 1, the outlet 26 has been pivoted by 90° with respect to the rest of the container body 10. This is achieved due to the resilient nature of the laminate material from which the container body 10 is formed. As a result of this pivoting of the outlet region, flow of feed F from the container 1 is facilitated.

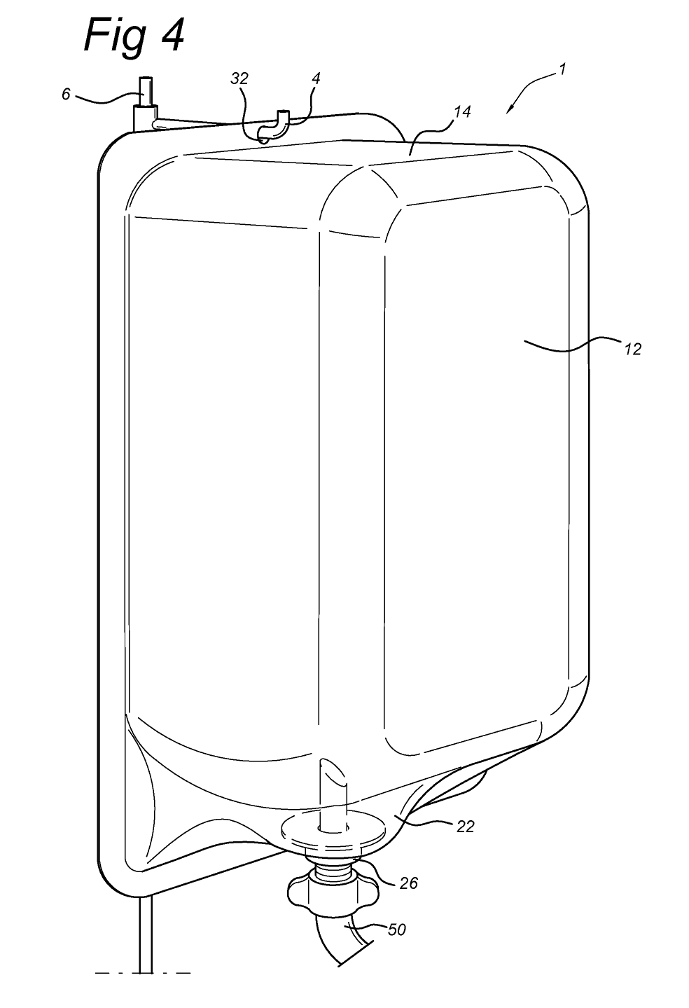

FIG. 4 shows the container 1 of FIG. 3 in perspective view showing opening 32, hook 4 and stand 6 with administration set 50 connected to the outlet 26.

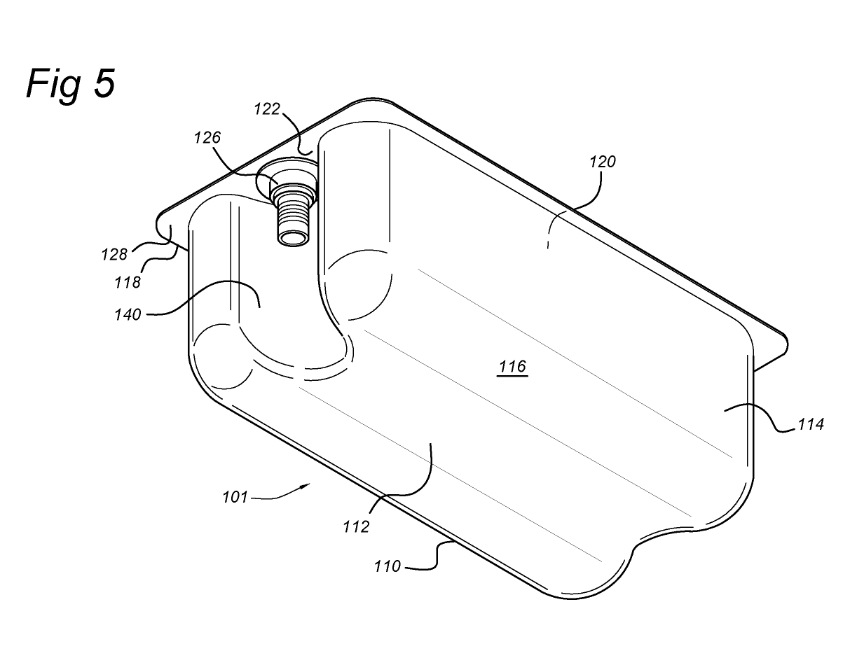

A second embodiment of the invention is shown in perspective view in its storage position according to FIG. 5. Like elements to those of FIG. 1 are denoted by similar reference numerals preceded by 100.

According to FIG. 5, the container 101 has a container body 110 having a generally horizontal base 112 and an upstanding sidewall 114 defining a product space 116. As in the first embodiment, the sidewall 114 terminates at a peripheral flange 118 which extends in a horizontal plane outwardly from the sidewall 114. A cover 120, closes the product space 116 and is connected to the peripheral flange 118 in a permanent weld 128.

According to the second embodiment, the sidewall 114 defines an outer profile having a recessed region 140, set back with respect to the remainder of the sidewall 114. The outlet region 122 carrying the outlet 126 is located within this recessed region 140. This construction has a number of advantages. Firstly, the recessed region 140 adds strength to the sidewall 114, making the container 101 more dimensionally stable and better for stacking. Secondly, the recessed region 140 receives the outlet 126 in a convenient manner and protects it during stacking and storage. Thirdly, it allows the sidewall 114 to flexibly pivot to an administration position that is relatively stable.

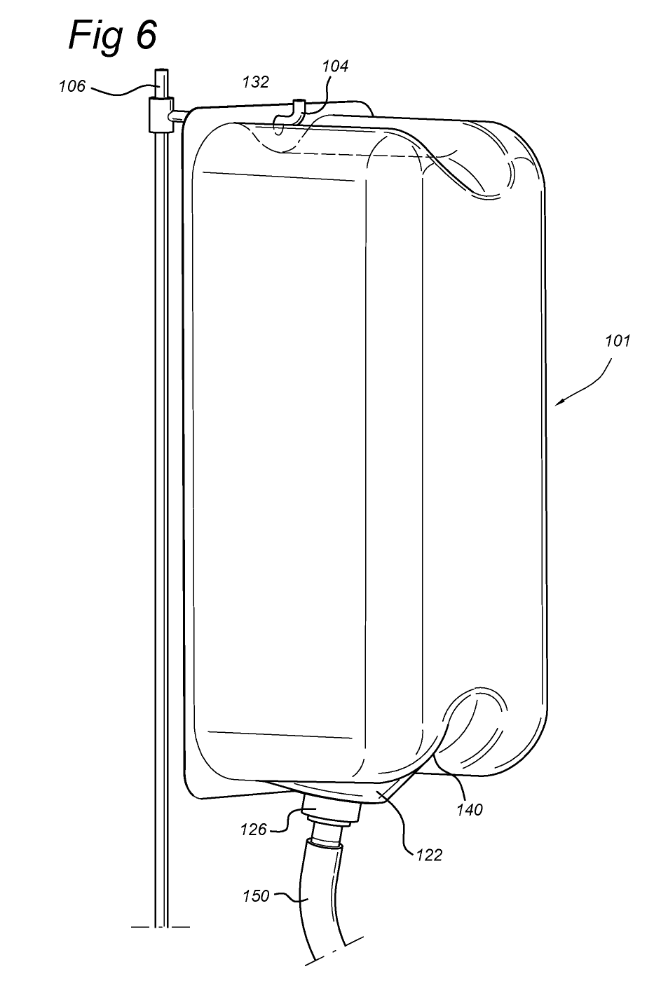

FIG. 6 shows the container 101 of FIG. 5 in its administration position supported by opening 132 from hook 104 and stand 106. An administration set 150 is connected to the outlet 126. In this position, outlet region 122 is pivoted downwards causing deformation of the recessed region 140. Due to the initial inward curve of the recessed region 140 in its storage position, pivoting to the administration position of FIG. 6 causes it to invert and adopt a stable configuration which maintains the outlet 126 pointing downwards.

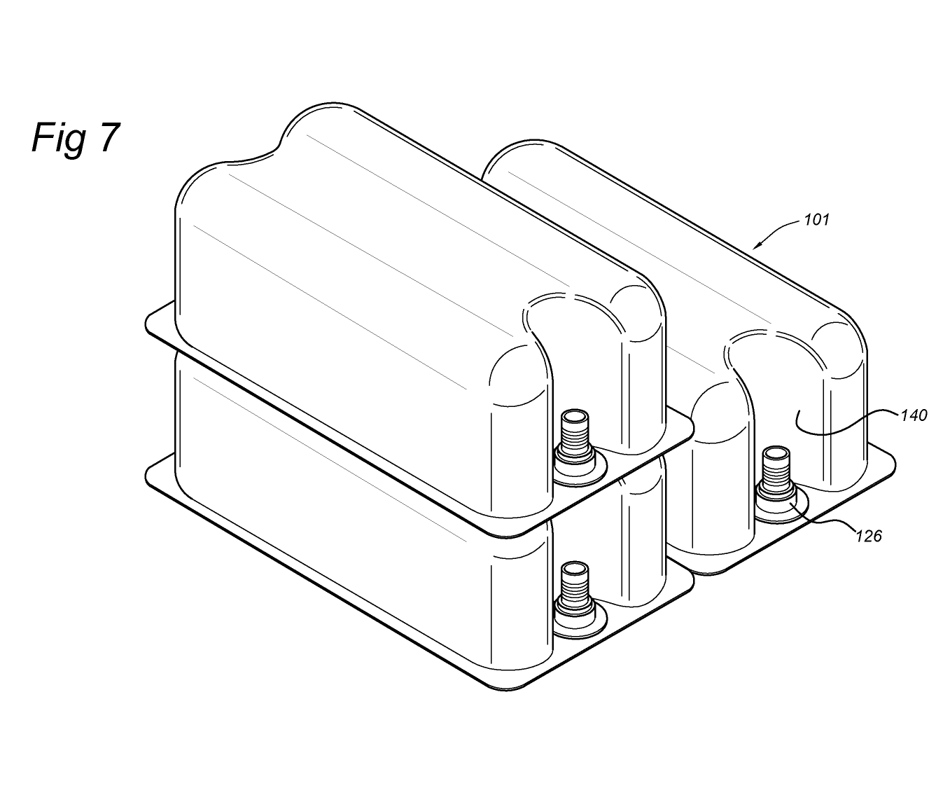

FIG. 7 shows in perspective view how a number of containers 101 according to the second embodiment may be stacked together with their outlets 126 recessed within the recessed regions 140. In this view the containers 101 are stacked on their covers 120 with their bases 112 facing upwards, although it will be understood that stacking on their bases 112 is also equally possible.

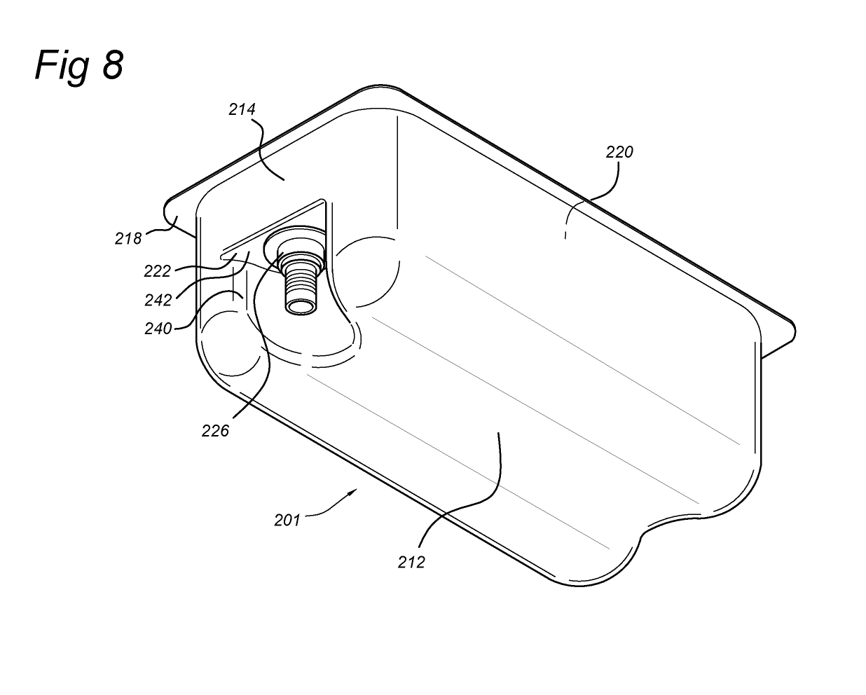

FIG. 8 shows a container 201 in perspective view according to a third embodiment of the invention. Like elements to those of FIG. 1 are denoted by similar reference numerals preceded by 200.

According to FIG. 8, the outlet region 222 is formed by a generally horizontal shelf 242 formed in the sidewall 214 at a position intermediate of the flange 218 and the base 212. In this manner, the outlet 226 is distanced from the cover 220 which may be preferable if an inner part of the outlet 226 extends into an interior of the container.

Thus, the invention has been described by reference to certain embodiments discussed above. It will be recognized that these embodiments are susceptible to various modifications and alternative forms well known to those of skill in the art. Many modifications in addition to those described above may be made to the structures and techniques described herein without departing from the spirit and scope of the invention. Accordingly, although specific embodiments have been described, these are examples only and are not limiting upon the scope of the invention.

1. A container for a liquid nutritional product, comprising:
a thermoformed polymeric container body having a base and an upstanding sidewall defining a product space, the upstanding sidewall terminating at a peripheral flange;
a cover, permanently sealed to the peripheral flange; and
an outlet, provided on an outlet region of the container body, defining a flow channel for the liquid nutritional product to leave the product space,
wherein, in a storage condition, the flow channel is directed at least partially downwards in a direction away from the cover and towards the base and wherein the outlet region is deformable to an administration position where the flow channel is directed sideways in a direction parallel to the base.

2. The container according to claim 1, wherein the outlet region is deformable between two stable positions defining the storage position and the administration position.

3. The container according to claim 1, wherein the outlet comprises a flange element, permanently connected to the outlet region.

4. The container according to claim 1, wherein the outlet comprises a tubular connector for connection to an administration set.

5. The container according to claim 1, wherein prior to use, the container body and the cover together hermetically seal the product space and whereby part of the outlet region aligned with the flow channel can be broken or pierced in order to the communicate the flow channel with the product space.

6. The container according to claim 1, wherein the outlet region is a shelf formed in the sidewall at a position intermediate of the flange and the base.

7. The container according to claim 1, wherein the sidewall defines a container profile and the outlet region is recessed within the container profile in its manufactured condition.

8. The container according to claim 1, wherein the container body is formed of a flexible material which can collapse during use to eliminate the product space.

9. The container according to claim 1, wherein the container body is formed of a relatively rigid material which can be stably stacked with at least one other similar container filled with liquid nutritional product.

10. A prefilled, sterile package comprising a container according to claim 1 filled with a quantity of aseptic liquid nutritional product.

11. A method of providing a prefilled, sterile package containing enteral feed, comprising:
thermoforming a polymer layer to form a container body having an upstanding sidewall, a peripheral flange and an outlet region;
filling the container with enteral feed;
applying a cover over the container body and sealing the cover to the peripheral flange;
sterilising the package; and
connecting an outlet to the outlet region.

12. The method of claim 11, whereby the outlet is connected to the outlet region by welding.

13. The method of claim 11, further comprising pivoting the outlet from a storage position to an administration position by deformation of the outlet region.

14. The method of claim 11, further comprising connecting an administration set to the outlet.

15. The method of claim 14, whereby connecting of the administration set causes rupture of a portion of the outlet region.

16. The method of claim 12, further comprising pivoting the outlet from a storage position to an administration position by deformation of the outlet region.

17. The method of claim 12, further comprising connecting an administration set to the outlet.

18. The method of claim 13, further comprising connecting an administration set to the outlet.

19. The container according to claim 2, wherein the outlet comprises a flange element, permanently connected to the outlet region.
